(19) United States
(12) Patent Application Publication
(10) Pub. No.: US 2010/0005197 A1
(43) Pub. Date: Jan. 7, 2010

(54) NETWORK DEVICE AND ACTIVE CONTROL CARD DETECTING METHOD

(75) Inventor: CHIH-YUAN HUANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/203,935

(22) Filed: Sep. 4, 2008

(30) Foreign Application Priority Data
Jul. 7, 2008 (CN) 200810302572.X

(51) Int. Cl. G06F 3/00

(52) U.S. Cl. 710/8

(57) ABSTRACT

A network device (100) includes a backplane (30), at least one line card (20) and a control card module (10). The control card module includes a first control card (12) and a second control card (14). The first control card or second control card is designated as an active control card, and the other as a standby control card. The active control card executes at least one application to communicate with other network devices. In addition, the application synchronizes the active control card with the standby control card by when status of one of the line cards changes. Upon detection of active control card failure, the standby control card transmits a switchover message to the line cards to implement registration of the standby control card as the active control card and transmits corresponding configurations to the line cards.

### BACKGROUND OF THE INVENTION

1. Field of the Invention

The present invention relates to network communication and particularly to a network device having at least one control card, and a method for detecting the active control card.

2. Discussion of the Related Art

Network devices, such as gateways, generally include at least one control card and a plurality of line cards connected by a bus and corresponding memory units. The line cards define a plurality of ports connecting to local area network or other terminals, transmitting data to the destinations. The flow of the data is determined by protocols executed on the control cards of the network devices. In operation, each status of the executed applications and protocols has to be recorded by the control card. In this case, the operation of the network device terminates when the control card fails, and the line card can only resume operations after the control card turns to its normal state.

In one solution to crashing due to failure of the control card, one active control card and one standby control card are provided in the network device. Each control card includes a processor and components for executing the applications and the protocols. The control cards and the line cards connect to each other via a backplane to provide data communication. In this case, the line cards transmit the data to both control cards to ensure that the standby control card is capable of taking over the tasks when the active control card fails.

However, the data transmitted from the line cards to the standby control card increases the load on the backplane as the data only has to be transmitted to the active control card during normal operation.

Therefore, there is room for improvement within the art.

### BRIEF DESCRIPTION OF THE DRAWINGS

Many aspects of the network device can be better understood with reference to the following drawings. The components in the drawings are not necessarily to scale, the emphasis instead being placed upon clearly illustrating the principles of the present network device. Moreover, in the drawings, like reference numerals designate corresponding parts throughout the several views.

FIG. 1 is a partial, isometric view of the network device according to an exemplary embodiment.

FIG. 2 is a flowchart illustrating a method of detecting an active control card of a network device when booting according to the exemplary embodiment.

FIG. 3 is a flowchart illustrating a method of detecting the active control card of the network device when the original active control card fails according to the exemplary embodiment.

### DETAILED DESCRIPTION OF THE EMBODIMENTS

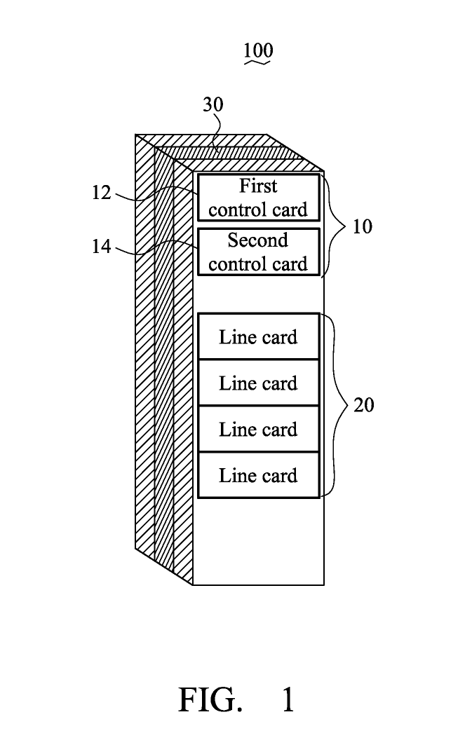

Referring to FIG. 1, a network device 100 includes a control card module 10, at least one line card 20, and a backplane 30. The control card module 10 and the line cards 20 are connected by the backplane 30. The line card 20 includes a plurality of ports communicating with the control card module 10 and other network devices (not shown). In the exemplary embodiment, the control card module 10 includes a first control card 12 and a second control card 14. In alternative embodiments, the control card module 10 may include more than two control cards.

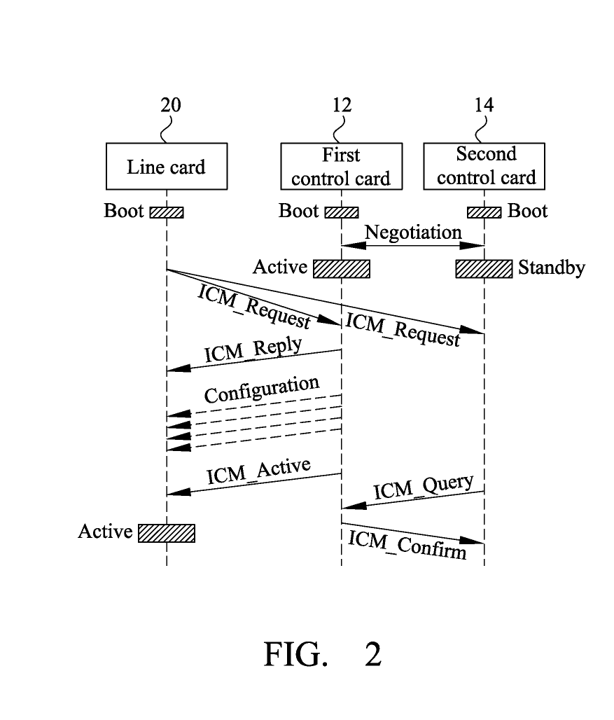

After a boot process, as shown in FIG. 2, the control card module 10 performs a negotiation procedure to determine which control card is active. In the negotiation procedure, the first control card 12 and the second control card 14 transmit control messages of the negotiation procedure by the backplane 30. The determination of the active control card is made by slot numbers, the media access control address (MAC address), or the boot time of the control cards. In the exemplary embodiment, the first control card 12 is designated as the active control card and the second control card 14 is designated as the standby control card.

Before the determination is made, the line card 20 periodically transmits an “ICM_Request (Internal Control Message Request) message” to the control card module 10 by the backplane 30 to inquire which control card is active. However, the control card module 10 will not reply until the determination is made.

As described, the first control card 12 may be designated as active and is in an “active” state after the boot process, and the second control card 14 is designated as the standby control card and is in a “standby” state. Upon determination, the first control card 12 transmits an “ICM_Reply (Internal Control Message Reply) message” to the line card 20 to confirm active status thereof. In addition, the first control card 12 also transmits corresponding configurations to the line card 20. The configurations include the slot number and the MAC address of the first control card 12. After the configurations are transmitted, the first control card 12 transmits an “ICM_Active (Internal Control Message Active) message” to implement transmission of data to line card 20.

In operation, the line card 20 only transmits data to the first control card 12, designated as active at this time. The communications between the line card 20 and other network devices are conducted by at least one application executed on the first control card 12. To conserve system resources, the line card 20 will not transmit data to the second control card 14, currently designated as in standby status.

When the first control card 12 detects that one of the line cards 20 fails or is removed, the first control card 12 informs the second control card 14 of such status to synchronize information between the active and standby control cards.

In addition, the standby control card periodically transmits an “ICM_Query (Internal Control Message Query) message” to the active control card to ensure normal operation. Upon receiving the “ICM_Query message”, the active control card responds with “ICM_Confirm (Internal Control Message Confirm) message” to confirm normal operation.

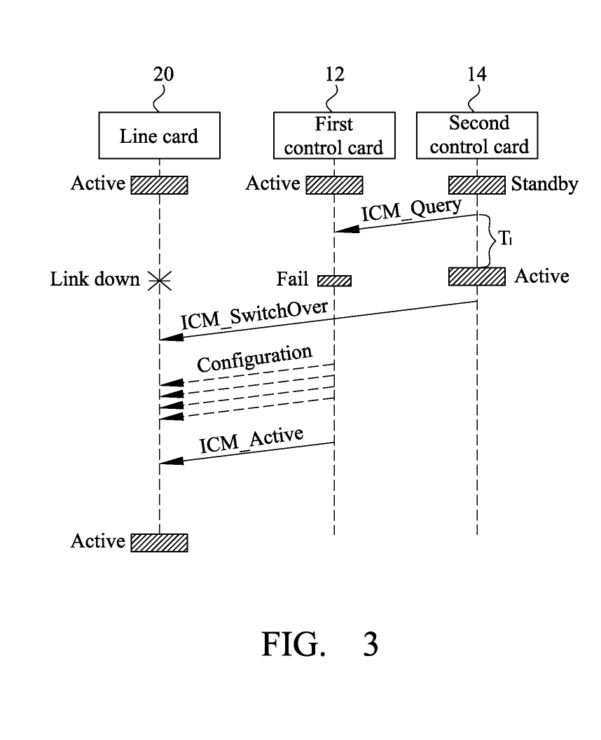

As shown in FIG. 3, after the “ICM_Query message” is sent by the standby control card, the second control card 14 determines first control card 12 failure if the “ICM_confirm message” is not received before a default time. In the exemplary embodiment, the default time may be changed.

Upon determining first control card 12 failure, the second control card 14 transmits an “ICM_SwitchOver (Internal Control Message Switch-Over) message” to the line card 20 to inform the line card 20 of original active control card, i.e., first control card 12, failure. After, the second control card 14 transmits corresponding configurations, i.e. the slot number and the MAC address, to the line card 20. After the configurations are transmitted, the second control card 14 transmits an “ICM_Active (Internal Control Message Active) message” to implement data transmission to the line card 20. In this way, the second control card 14 takes over the tasks of the first control card 12.

Understandably, the first control card 12 may be designated as the standby control card and the second control card 14 may be designated as active.

In the exemplary embodiment, the network device 100 may further include a control terminal (not shown) allowing status of the control cards and the line card 20 to be monitored. Upon detection of active control card failure, the standby control card transmits a failure message of the status of the active control card.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A network device comprising:
a backplane;
at least one line card; and
a control card module comprising a first control card and a second control card, one of which is designated as an active control card, and the other of which is designated as a standby control card;
wherein the active control card executes at least one application to communicate with other network devices; and
the application synchronizing the statuses of the active control card and the standby control card if the status of one of the line cards changes, whereby the standby control card transmits a switchover message to the line cards to implement registration of the standby control card as the active control card and transmits corresponding configurations to the lines card upon detection of active control card failure.

2. The network device as claimed in claim 1, wherein the control card module further comprises a plurality of control cards.

3. The network device as claimed in claim 1, wherein the configurations comprise media access address of the control card.

4. The network device as claimed in claim 1, wherein the line card comprises a plurality of ports communicating with the control cards.

5. The network device as claimed in claim 1, wherein the control card module and the line cards communicates with each other via the backplane.

6. The network device as claimed in claim 1, wherein the standby control cards periodically transmit a query message to the active control card to determine if the active control card is functioning normally.

7. The network device as claimed in claim 1, wherein the active control card transmits a confirmation to the standby control card to confirm normal operation.

8. The network device as claimed in claim 7, wherein the standby control card determines active control card failure if the confirm message is not received after a default time.

9. The network device as claimed in claim 8, wherein the standby control card transmits a failure message to a control terminal upon detection of active control card failure.

10. A method of detecting an active control card of a network device, the network device comprising at least one line card and a control card module comprising a first control card and a second control card, the method comprising:
designating the first control card or the second control card as the active control card, and the other of which is designated as a standby control card;
the line cards transmitting a request to identify the active control card;
the active control card transmitting a reply notifying the line cards of the active control card and transmitting corresponding configurations to the line card;
the active control card executing at least one application to communicate with other network devices;
the at least one application synchronizing the statuses of the active control card and the standby control card if the status of one of the line card changes;
transmitting a switchover message implementing registration of the standby control card as the active control card and transmitting corresponding configurations to the line cards upon detection of active control card failure.

11. The method as claimed in claim 10, wherein the request message is sent by the line card after a boot procedure.

12. The method as claimed in claim 10, wherein the configurations comprise media access address of the control card.

13. The method as claimed in claim 10, wherein the line card comprises a plurality of ports communicating with the control cards.

14. The method as claimed in claim 10, wherein the control card module and the line cards communicate with each other via the backplane.

15. The method as claimed in claim 10, wherein the standby control cards periodically transmit a query message to the active control card to confirm normal operation.

16. The method as claimed in claim 15, wherein the active control card transmits a confirmation to the standby control card to confirm normal operation.

17. The method as claimed in claim 16, wherein the standby control card determines active control card failure if the confirm message is not received before a default time.

18. The method as claimed in claim 17, wherein the standby control card transmits a failure message to a control terminal upon detection of active control card failure.
